(19) United States
(12) Patent Application Publication
(10) Pub. No.: US 2002/0109758 A1
(43) Pub. Date: Aug. 15, 2002

(54) Ink supply mechanism and ink jet recording apparatus

(75) Inventor: Takeshi Kono, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/058,801

(22) Filed: Jan. 30, 2002

(30) Foreign Application Priority Data
Feb. 9, 2001 (JP) 2001/033777

(51) Int. Cl. B41J 2/175

(52) U.S. Cl. 347/85

(57) ABSTRACT

An ink supply mechanism comprises an ink supply tube for supplying ink to a recording head, an ink supply needle communicated with a liquid flow path, and an air inducing needle communicated with an atmospheric communication port. The ink supply needle and the air inducing needle are communicated with the inside of a main tank by being penetrated through rubber plugs provided for the bottom of the main tank, respectively, to enable liquid paths to be communicated through the main tank. Also, both the ink supply needle and the air inducing needle are formed by conductive material, and a circuit is connected therewith to measure the electrical resistance of ink. The flow path is communicated with the atmospheric communication port by way of a portion positioned higher than the upper opening of the air inducing needle. With the structure thus arranged, the ink supply mechanism prevents ink from leaking from the atmospheric communication port.

### BACKGROUND OF THE INVENTION

1. Field of the Invention

The present invention relates to an ink supply mechanism for supplying ink to an ink jet head, and also, relates to an ink jet recording apparatus.

2. Related Background Art

Of the recording methods for a printer or the like, the ink jet recording method that records on a recording medium, such as a recording paper sheet, by discharging ink from the discharge ports (nozzles) has been widely adopted in recent years, because it performs recording operation at high speed in high density by use of the low-noise non-impact recording method.

In general, an ink jet recording apparatus comprises means for driving a carrier that mounts an ink jet head thereon; conveyance means for conveying a recording paper sheet; and control means for controlling them, among some others. Also, there is the one which uses electromechanical converting elements, such as piezoelectric elements, to exert pressure on ink in order to generate energy for discharging ink from the nozzle portion of an ink jet heat; irradiates electromagnetic waves, such as laser, to generate heat; generates heat for bubbling; or uses electrothermal converting elements each having heat resistive element for heating liquid for bubbling. Among them, the ink jet recording apparatus that adopts the method for discharging ink droplets utilizing thermal energy makes it possible to perform recording in high resolution with the nozzles that can be arranged in high density. Particularly, the ink jet head that uses electrothermal converting elements as energy generating elements can be made smaller with ease, and by the application of the IC technologies and micro-machining techniques, which have made remarkable technical advancement and enhancement of reliability in the field of semiconductor manufacturing in recent years, the ink jet head of the kind can be assembled in high density at lower costs utilizing the advantages of these technologies and techniques sufficiently.

Now, FIG. 5 shows one example of the conventional ink jet recording apparatus that adopts the method of discharging ink droplets utilizing thermal energy, in which the discharge nozzle 101g of a recording head 101 is a fine hole. There is no particular valve mechanism provided for the nozzle. With the interior of the nozzle being kept in negative pressure, the nozzle enables ink to be given meniscus to prevent ink leakage from the nozzle, as well as to prevent the air from entering the nozzle from the atmosphere. Ink is discharged by pushing out ink in the discharge nozzle 101g by means of film-boiling energy of the heater arranged in the vicinity of the discharge nozzle 101g. After discharge, ink is filled again in the nozzle by means of capillary force of the discharge nozzle 101g. This cycle is repeated, and ink is absorbed from the main tank 104 through a tube 106 as required.

In the recording head 101, there are arranged a filter 101c having a fine mesh structure to prevent the discharge nozzle 101g, which is a fine hole, from being clogged by dust particles; the flow path 101f that connects the filter 101c and the discharge nozzle 101g; and the sub-tank 101b for retaining ink in a given amount, which is arranged on the upstream side of the filter 101c, here, ink being supplied thereto by way of the tube 106 from the main tank 104 installed on the main body of the ink jet recording apparatus.

The main tank 104 and the supply base 105 are structured as disclosed in the specification of Japanese Patent Publication 2929804, and the liquid connector 104b on the bottom face of the main tank 104 is detachably installed on two hollow needles 105a and 105b fixed to the supply base 105.

In the supply base 105, there is arranged the ink chamber 105f which is released to the atmosphere by means of an atmospheric port 105g. The hollow needles 105a and 105b are arranged in such a manner that the height of the low end of the hollow needle 105b is made different from that of the hollow needle 105a so as to keep it in ink in the ink chamber 105f. The ink chamber 105f is structured to be communicated with the tube 106 from the bottom portion of the ink chamber 105f. Then, when the lower end of the hollow needle 105b appears on the liquid surface of the ink chamber 105f as the liquid surface of the ink chamber 105f is lowered following the reduction of ink in the ink chamber 105f due to ink consumption, the air enters the interior of the main tank 104 from the lower end of the hollow needle 105b. Thus, ink in the main tank 104 flows out to the ink chamber 105f to raise the liquid surface of ink in the ink chamber 105f to cause the lower end of the hollow needle 105b to be immersed again in ink. With the structure thus formed, ink in the main tank 104 is drawn out gradually.

Also, on the lower part of the main tank 104, the electrode 104e is arranged to be in contact with ink, which is in conduction with the contact point 105j provided for the supply base 105. To the contact point 105j and the hollow needle 105b, the detection circuit 105h, which measures the electric resistance of ink, is connected to detect the presence and absence of ink.

In the sub-tank 101b, the air that permeates the resin material of the tube 106 or the like to enter the sub-tank, and the air dissolved and retained in ink is accumulated as well. Therefore, the accumulated excessive air is sucked out together with ink periodically from the side wall of the sub-tank 101b by means of the exhaust tube 110a and the exhaust pump 110c. Then, the sub-tank is closed by the valve 110b when the exhaust is completed to maintain the ink discharge characteristics.

Also, if overly viscous ink causes the discharge nozzle 101g to be clogged or any excessive bubble that may be generated at the time of discharge ensues in clogging, the recovery of ink discharge characteristics is made by sucking ink intensively from the discharge nozzle 101g by means of the suction pump provided for the suction cap 107a of the recovery unit 107.

Now, however, even if a step is taken to deal with any unexpected movement of ink (such as ink being returned from the head side to the ink chamber 105f) with the provision of a mechanism, which is additionally provided for the ink supply mechanism of the conventional structure exemplified as described above, to close the tube 106 on the midway when operation is at rest, there is still a possibility that ink flows out externally from the atmospheric communication port 105g if the apparatus shown in FIG. 5 is inclined to make its right side higher, for example, due to the occurrence of unusual situation under which the apparatus shown in FIG. 5 moves to change its installation site.

Further, when the ink liquid surface of the ink chamber 105f is caused to part from the end portion of the hollow needle 105b, the leading end of the hollow needle 105b is released to the atmosphere. In this state, the air is induced from the hollow needle 105b into the main tank 104, and ink in the main ink tank 104 flows out to the ink chamber 105f along with the induction of the air. Thus, unless the leading end portion of the hollow needle 105b is clogged by ink, ink in the main tank 104 flows out continuously, and in the worst case, there may occur the event that all ink in the main tank 104 flows out into the ink chamber 105f. The ink chamber 105f is not capable enough to receive all ink in the main tank 104. As a result, ink that flows out from the ink chamber 105f is allowed to flow out externally from the atmospheric communication port 105g eventually. In addition, if the volume of the ink chamber 105f is made large enough to receive all ink in the main tank 104, the structure of the apparatus becomes extremely large, which is not practicable.

Meanwhile, it is an important technique to detect ink remainders in an ink jet recording apparatus in order to protect the head or avoid wasting an object to print on eventually. For example, the structure shown in FIG. 5, in which electrodes are buried in the main tank for purpose of detecting ink remainders, needs the provision of electrodes and more parts at the connecting point therebetween, thus resulting in the increased costs of the apparatus and the main tank inevitably.

Here, for example, the hollow needles 105a and 105b are connected to the detection circuit to form a structure whereby to detect the resistance of ink residing between the two hollow needles in the main tank 104. With this structure, however, the resistance of ink is detected as far as ink exists in the ink chamber 105f even when there is no ink in the main tank 104, and the result of detection may sometimes indicate the presence of ink in the main tank 104, because the hollow needles 105a and 105b are in contact through ink in the ink chamber 105f. Also, even when the main tank 104 is removed, the detection is effectuated to indicate the presence of ink if ink remains in the ink chamber 105f. As a result, irrespective of the presence or absence of the main tank 104, detection indicates that ink is in the normal status, leading to a drawback that the installation status of main tank is not detectable.

### SUMMARY OF THE INVENTION

With a view to solving the problems discussed above, the present invention is designed to aim at the provision of the ink supply mechanism capable of maintaining the ink supply status stably without being affected by the status (conditions in movement and installation site) of the ink jet recording apparatus that uses such mechanism, as well as the provision of an ink jet recording apparatus.

It is another object of the invention to provide an ink supply mechanism structured to make it difficult for ink in the main tank to leak from the atmospheric communication port, and an ink jet recording apparatus as well.

It is still another object of the invention to provide an ink supply mechanism capable of detecting the presence and absence of ink in the main tank, as well as detecting with ease the state of the main tank being mounted or unmounted, and also to provide an ink jet recording apparatus.

In order to achieve the objects described above, the ink supply mechanism of the present invention for an ink supply device that supplies ink from an ink tank to a recording head comprises an ink tank freely attachable and detachable, which retains ink therein with two connectors provided for the bottom thereof for enabling the inside thereof to be communicated with the outside. For this ink supply mechanism, a first hollow needle, which is communicated with the ink supply path for supplying ink to the recording head, is inserted into one of the connectors for communication, and a second hollow needle, which is communicated with the bottom of the atmospheric communication chamber communicated with the atmosphere through an atmospheric communication port, is inserted into the other one of the connectors for communication in order to form one flow path airtightly closed to the atmosphere from the atmospheric communication port to the ink supply path through the ink tank.

The ink supply device structured as described above enables the first hollow needle connected with the ink supply path and the second hollow needle communicated with the bottom end of the atmospheric communication chamber communicated with the atmosphere through the atmospheric communication port to be inserted into each of the connectors of the ink tank for communication, thus forming one flow path airtightly closed to the atmosphere from the atmospheric communication port to the ink supply path through the ink tank. In other words, with the formation of one airtightly closed flow path from the atmospheric communication port to the ink supply path, it becomes possible to eliminate the flow-in of the air on the midway of the flow path, and the ink leakage as well, and also, to block the movement of ink in the flow path.

Also, for the ink supply device of the present invention, the first hollow needle and the second hollow needle are formed by conductive material, and a circuit may be provided to measure the value of electric resistance between the first and second hollow needles. In this case, the ink that resides between the two hollow needles is only ink in the ink tank. As a result, there is no possibility that the resistance of any ink residing outside the ink tank is detected unexpectedly.

Further, the atmospheric communication chamber is a space expanded from the lower end of the second hollow needle upward, and the atmospheric communication port provided for the atmospheric communication chamber may be arranged at a position higher than the opening of the second hollow needle on the insertion side thereof into the connector for communication, and part of the path between the atmospheric communication port and the second hollow needle may be positioned to be higher than the opening of the second hollow needle on the insertion side thereof into the connector for communication. In this case, it becomes possible to prevent ink leakage from the atmospheric communication port even if the ink tank is mounted erroneously without the installation of the recording head, for example. Also, with the structure of the atmospheric communication chamber as a space expanding from the lower end of the second hollow needle upward, it becomes possible to enable ink in the atmospheric communication chamber to return to the main tank reliably even when the environmental condition is restored while ink has leaked into the atmospheric communication chamber due to the environmental changes or the like or even if ink is supplied while the recording is performed in a state of ink residing in the atmospheric communication chamber. In this way, there is no possibility that ink is consumed wastefully.

Also, the volume of the atmospheric communication chamber may be set to satisfy Va>Vt×(T₂−T₁)/T₂ where T₁ is the lower limit temperature of use environmental temperature; T₂ is the upper limit temperature of use environmental temperature; Va is the volume of the atmospheric communication chamber; and Vt is the volume of the ink tank. In this case, even if the temperature of the use environment is caused to change to push out ink due to the resultant changes of inner pressure of the ink tank, the atmospheric communication chamber has the volume good enough to function as a buffer chamber for the ink that has been pushed out, thus retaining ink thus pushed out to prevent ink leakage from the atmospheric communication port.

The ink supply mechanism of the present invention comprises an ink supply path for supplying ink to a recording head connected with an ink tank capable of being attached to and detached from a recording apparatus; and an atmospheric communication path connected with the ink tank to condition the ink tank to be communicated with the atmosphere. For this supply mechanism, the ink supply path and the atmospheric communication path are made communicative as one path through the ink tank only in the state of being connected with the ink tank, and the ink supply path and the atmospheric communication path are cut off when the ink tank is not mounted.

With the ink supply mechanism of the present invention thus structured, it becomes possible to make the ink supply path and the atmospheric communication path one communicative path through the ink tank. In other words, the passage between the atmospheric communication port and the ink supply path is made one flow path which is airtightly closed to eliminate the flow-in of the air from the midway of the flow path, and the ink leakage as well, while blocking the movement of ink in the flow path. Also, when ink is not mounted, the ink supply path and the atmospheric communication path is cut off to condition them to be independent from each other. For example, therefore, if only the electrical conduction across the ink supply path and the atmospheric communication path is examined, it becomes possible to determine whether or not the ink tank is mounted.

The ink jet recording apparatus of the present invention is provided with conveying means for conveying a recording medium to perform recording by discharging ink from a recording head to the recording medium, which comprises an ink supply mechanism of the present invention.

The ink jet recording apparatus of the invention structured as described above is provided with the ink supply device of the invention to make it possible to prevent ink leakage from the atmospheric communication port. Also, the presence and absence of ink in the ink tank can be grasped exactly. Whether or not the ink tank is mounted can be grasped, too.

### BRIEF DESCRIPTION OF THE DRAWINGS

FIG. 1 is a perspective view that schematically shows the structure of an ink jet recording apparatus in accordance with one embodiment of the present invention;

FIG. 2 is a view that illustrates the detailed structure of the ink supply system of an ink jet recording apparatus in accordance with one embodiment of the present invention;

FIGS. 3A, 3B, 3C and 3D are views that illustrate the behavior of air and ink in the liquid paths of an ink supply unit when the air is inducted into the main tank;

FIG. 4 is a view that illustrates the pressure exerted on the nozzle by means of water head difference; and

FIG. 5 is a view that illustrates the one structural example of the ink supply system of the conventional ink jet recording apparatus.

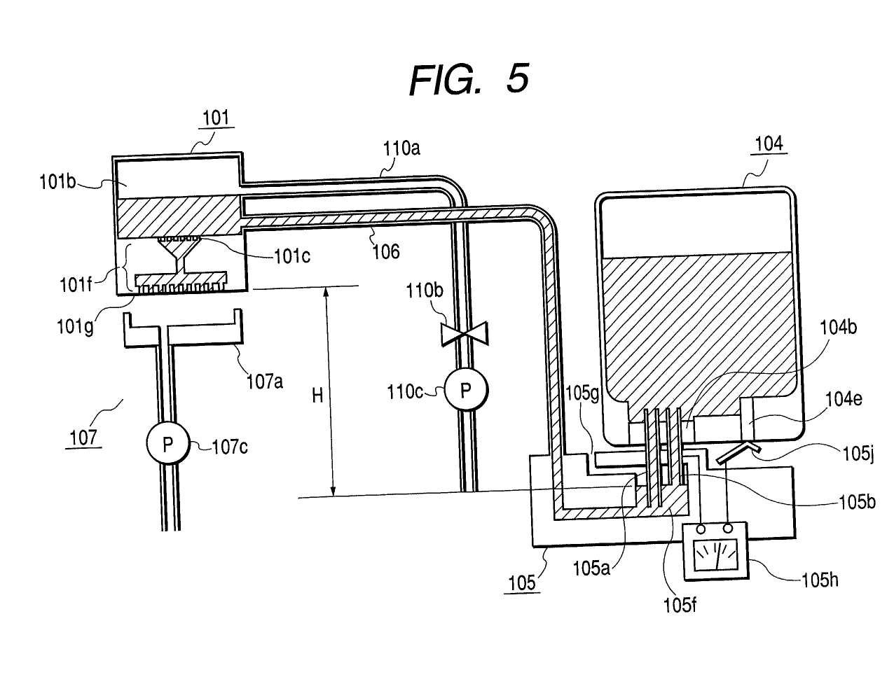

### DETAILED DESCRIPTION OF THE PREFERRED EMBODIMENTS

Now, with reference to the accompanying drawings, the detailed description will be made of the embodiments in accordance with the present invention.

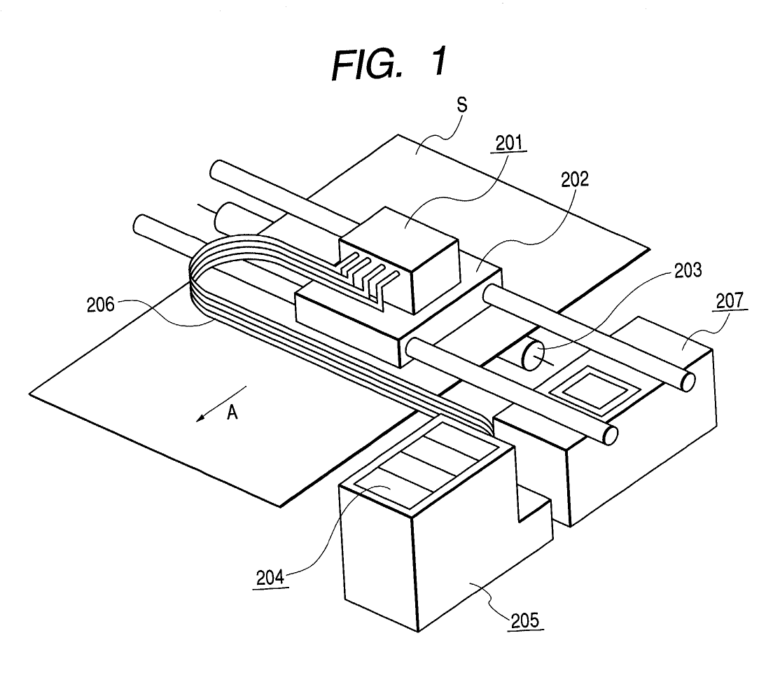

FIG. 1 is a perspective view that schematically shows the structure of an ink jet recording apparatus in accordance with one embodiment of the present invention.

The ink jet recording apparatus shown in FIG. 1 is a serial type recording apparatus in which while the reciprocation (main scanning) of the recording head 201, and the conveyance (sub-scanning) of a general recording paper sheet, a special paper sheet, an OHP film, or other recording sheet S at a designated pitch are repeated, ink is selectively discharged from the recording head 201 in synchronism with such repeated movement to enable ink to adhere to the recording sheet S for the formation of characters, images, or the like.

In FIG. 1, the recording head 201 is detachably mounted on the carriage 202 slidably supported by two guide rails, which reciprocates along the guide rails by driving means such as a motor (not shown). The recording sheet S faces the ink discharge surface of the recording head 201 by means of the conveying roller 203. Then, it is conveyed in the direction intersecting with the traveling direction of the carriage 202 (the orthogonal direction indicated by an arrow A, for instance), while maintaining a distance with the ink discharge surface constantly.

The recording head 201 is provided with a plurality of nozzle arrays for discharging ink of different colors, respectively. For ink of different colors to be discharged from the recording head 201, individual main tanks 204 are detachably mounted on the ink supply unit 205. The ink supply unit 205 and the recording head 201 are connected by use of a plurality of ink supply tubes 206 in accordance with ink of different colors, respectively. Then, when the main tank 204 is mounted on the ink supply unit 205, it becomes possible to supply ink of each color retained in the main tank 204 to each of the nozzle arrays of the recording head 201 independently.

Within the reciprocation range of the recording head 201 but in the non-recordable area, which is out of the passing range of the recording sheet S, there is arranged the recovery unit 207 facing the ink discharge surface of the recording head 201.

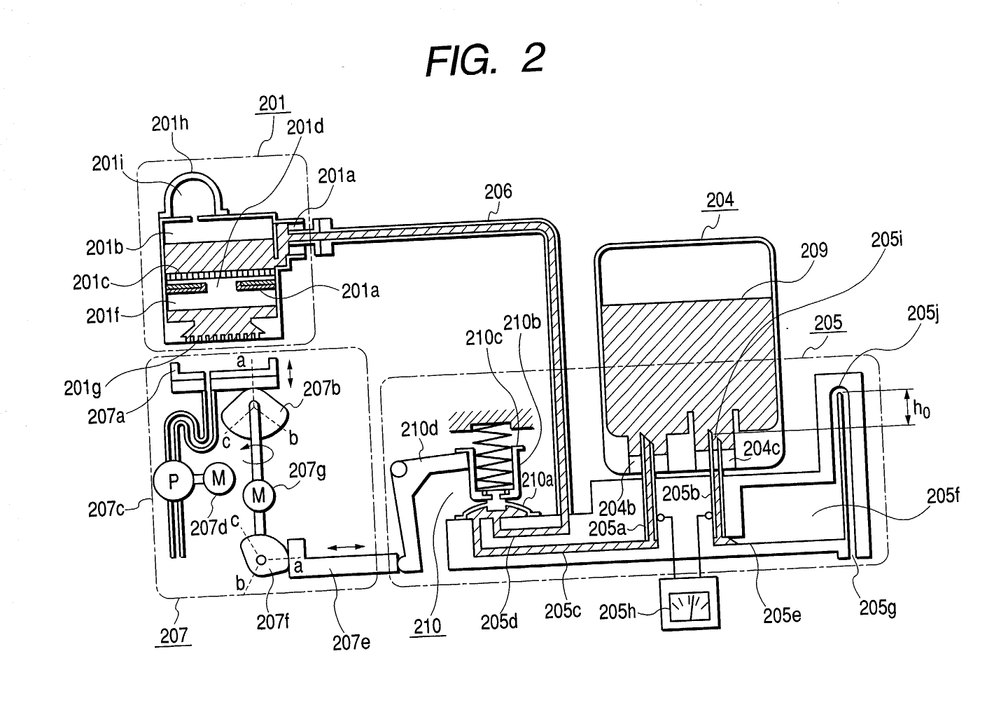

Next, with reference to FIG. 2, the description will be made of the detailed structure of the ink supply system of the ink jet recording apparatus. FIG. 2 is a view illustrating the ink supply passage of the ink jet recording apparatus shown in FIG. 1. In order to simplify the description, only the path for one color portion is represented therein.

At first, the recording head 201 will be described.

To the recording head 201, ink is supplied from the connector insertion port 201a having a liquid connector airtightly connected therewith, which is arranged at the leading end of the ink supply tube 206. The connector insertion port 201a is communicated with the sub-tank 201b formed on the upper part of the recording head 201. Below the sub-tank 201b, the liquid chamber 201f is formed to supply ink directly to the nozzle unit provided with a plurality of nozzles 201g arranged in parallel. The sub-tank 201b and the liquid chamber 201f are partitioned by use of the filter 201c, but there is arranged a partition 201e having an opening 201d formed therefor on the boundary between the sub-tank 201b and the liquid chamber 201f. The filter 201c is installed on the partition 201e.

With the structure thus arranged, the ink, which is supplied from the connector insertion port 201a to the recording head 201, is supplied to the nozzle 201g through the sub-tank 201b, the filer 201c, and the liquid chamber 201f. The passage between the connector insertion port 201a and nozzle 201g is kept in a state of being airtight to the atmosphere.

On the upper face of the sub-tank 201b, an opening portion is formed. The opening portion is covered by a domed elastic material 201h. The space encircled by the elastic material 201h (a pressure adjustment chamber 201i) is capable of changing the volume thereof in accordance with the pressure in the sub-tank 201b, and functions to adjust the pressure in the sub-tank 201b to be described later.

The nozzle 201g is formed to be cylindrical having the sectional width of approximately 20 μm, and ink is discharged from the nozzle 201g when ink in the nozzle 201g is given discharge energy. Then, after ink is discharged, ink is filled in the nozzle 201g by means of the capillary force of the nozzle 201g. Usually, the discharge is repeated with cycle of 20 kHz or more so as to form images precisely at high speed. In order to give the discharge energy to ink in the nozzle 201g, the recording head 201 is provided with energy generating means per nozzle 201g. For the present embodiment, the heat generating resistive element is used as energy generating means for heating ink in the nozzle 201g, which is selectively driven by the instruction from the head controller (not shown) that controls the driving of the recording head 201, thus generating film boiling in ink in a desired nozzle 201g. The pressure of bubble generated in this manner is utilized for discharging ink from the nozzle 201g.

Each of the nozzles 201g is arranged with its ink discharging tip downward, but there is no valve mechanism arranged to close such tip. Ink is filled in the nozzle 201g in condition that it forms meniscus. As a result, the interior of the recording head 201, particularly inside the nozzle 201g, is kept in a state of being negatively pressurized. However, if the negative pressure is too small, the meniscus of ink is broken to cause ink to leak from the nozzle 201g should foreign substance or ink adhere to the discharging tip of the nozzle 201g. On the contrary, if the negative pressure is too large, the force that draws ink into the nozzle 201g becomes greater than the energy given to ink at the time of discharge, resulting in defective discharge. Therefore, the negative pressure in the nozzle 201g should preferably be within a range of approximately −0.4 kPa to approximately −2.0 kPa according to the results of experiments carried out by the inventors hereof (here, the specific gravity of ink is assumed to be that of water), although it differs depending on the setting number of nozzles 201g, the sectional area of each nozzle, and the performance of each heat generating resistive element, among some others.

In accordance with the present embodiment, the ink supply unit 205 and the recording head 201 are connected with the ink supply tube 206, and the recording head 201 can be positioned comparatively freely to the ink supply unit 205 to make it possible to arrange the recording head 201 at a position higher than the ink supply unit 205 for making the inner pressure of the recording head 201 negative. As regards this height, the description will be made further in detail.

The filter 201c is formed by the metal mesh having fine holes of less than 10 μm each, which is smaller than the sectional width of the nozzle 201g, in order to prevent any foreign substance that may clog the nozzle 201g from flowing out into the liquid chamber 201f from the sub-tank 201b. For the filter 201c, the meniscus of ink is formed in each fine hole by means of capillary force if ink is in contact with only one face of the filter 201c, thus presenting the property that makes ink to be transmitted with ease, but makes the flow of air difficult. The smaller the size of fine hole, the stronger is the intensity of meniscus to make it more difficult for the air to pass.

For the filter 201c used for the present embodiment, the pressure needed for the transmission of the air is approximately 10.1 kPa (experimental value), Therefore, if the air resides in the liquid chamber 201f positioned on the downstream of the filter 201c in the direction of ink movement in the recording head 201, the air cannot pass the filter 201c only by the floatation of the air itself or the like. As a result, the air in the liquid chamber 201f remains in the liquid chamber 201f. For the present embodiment, this phenomenon is utilized, and while the liquid chamber 201f is not filled with ink, a specific amount of ink is retained in the liquid chamber 201f so as to enable the air layer between ink in the liquid chamber 201f and the filter 201c.

The amount of ink that should be retained in the liquid chamber 201f is the minimum amount of ink required to fill in the nozzle 201g. If the air enters the nozzle 201g from the liquid chamber 201f, ink cannot be replenished in the nozzle 201g after ink has been discharged, and defective discharge may ensue. It is necessary, therefore, to fill the nozzle 201g with ink at all times.

With the upper face of the filter 201c, ink in the sub-tank 201b is in contact, and the area where ink is in contact is the effective area of the filter 201c. As described in conjunction with the conventional art, the pressure loss caused by the filter 201c depends on the effective area of the filer 201c. In accordance with the present embodiment, the filter 201c is arranged to be horizontal to the recording head 201 when it is in use so that ink is in contact with the entire upper face of the filter 201c to maximize the effective area of the filter for the reduction of the pressure loss.

The pressure adjustment chamber 201i is a chamber the volume of which is reduced as the negative pressure increases in it. It is preferable to use a rubber material or the like for the elastic member 201h if the pressure adjustment chamber 201i is formed by the elastic member 201h as in the case of the present embodiment. Also, besides the use of the elastic member 201h, it may be possible to combine a plastic sheet and a spring for the structure thereof. The volume of the pressure adjustment chamber 201i is set depending on the environmental temperature at which the recording head 201 is used, and the volume of the subtank 201b or the like as well, but for the present embodiment, it is set at approximately 0.5 ml.

If there is no provision of any pressure adjustment chamber 201i, the pressure in the sub-tank 201b directly receives the resistance that may be caused by the pressure loss when ink passes the main tank 204, the ink supply unit 205, and the ink supply tube 206. Therefore, in the case of the so-called high-duty that requires ink discharges at higher rate, such as discharging ink from all the nozzles 201g, the ink supply to the recording head 201 tends to become short against such an amount of ink to be discharged, hence raising the negative pressure abruptly. If the negative pressure of the nozzle 201g exceeds the aforesaid limited value of approximately −2.0 kPa, the discharges become unstable to ensue in the unfavorable condition of the image formation.

For the serial type recording apparatus of the present embodiment, when the carriage 202 (see FIG. 1) returns, the ink discharge is conditioned to be at rest even if the image formation is of the high-duty. The pressure adjustment chamber 201i performs a capacitor-like function such as to make the increase of negative pressure easier in the sub-tank 201b by reducing the volume thereof during ink discharge, and to restor it when the carriage returns.

Now, for example, ink supplied against ink discharged is considered to be ΔV=0.05 ml short on assumption that the changing ratio of the negative pressure against the reduction of the volume of the pressure adjustment chamber 201i is K=−1 kPa/ml, and the volume of the sub-tank 201b is Vₛ=2 ml. In this case, if there is no pressure adjustment chamber 201i, the changes of the negative pressure in the sub-tank 201b become ΔP=Vₛ/(Vₛ+ΔV)−1=−2.3 kPa by the principle of “PV=constant”. As a result, the negative pressure exceeds the aforesaid limited value to make the discharge instable. In contrast, if the pressure adjustment chamber 201i exists, the ΔP becomes equal to K×ΔV=−51 Pa, hence suppressing the increase of the negative pressure to make the discharge stable.

As described above, the stabilization of ink discharges are attempted by the provision of the pressure adjustment chamber 201i, while suppressing the influence of the pressure loss in the ink supply passage from the main tank 204 to the recording head 201. As a result, it becomes possible to use the ink supply tube 206 of a smaller diameter, which should follow the movement of the carriage 202, thus contributing to the reduction of load when the carriage 202 moves.

Next, with reference to FIGS. 2, 3 and 4, the description will be made of the ink supply unit 205 and main tank 204 that form the ink supply mechanism.

As shown in FIG. 2, the main tank 204 is structured to be attachable to and detachable from the supply unit 205. On the one side thereof, there are provided an ink supply port that can be closed with a rubber plug 204b, and an air inlet port closed with a rubber plug 204c. The main tank 204 is an airtight container by itself. Ink 209 is directly contained in the main tank 204. The ink supply port and the air inlet port of the main tank 204 are provided for the side face which correspond to the bottom face of the ink tank in the posture of being mounted.

On the other hand, as shown in FIG. 2, the ink supply unit 205 is provided with an ink supply needle 205a for drawing ink 209 from the main tank 204, and an air inducing needle 205b for inducing the air outside into the main tank 204. Both the ink supply needle 205a and the air inducing needle 205b are conductively hollow, and the needle tips are arranged upward in the setting state of the ink jet recording apparatus, corresponding to the positions of the ink supply port and air inducing port of the main tank 204. It is arranged that when the main tank 204 is installed as if dropped down from above to bottom of the ink supply unit 205, the ink supply needle 205a and the air inducing needle 205b penetrate the rubber plugs 204b and 204c, respectively, and enter the interior of the main tank 204.

Here, the flow path on the ink supply needle 205a side and the flow path on the air inducing needle 205b side are structured completely as each independent system. There is no structure that enables both the flow path on the ink supply needle 205a side and the flow path on the air inducing needle 205b side to be communicated with each other. However, these independent flow paths on the ink supply needle 205a side and air inducing needle 205b side are made one communicative flow path when the main tank 204 is installed on the ink supply unit 205. The structure is arranged so that the flow paths on the ink supply needle 205a side and the air inducing needle 205b side are separated as independent flow paths when the main tank 204 is not installed. With the flow paths thus structured, one flow path, which is closed between the air inducing port and the ink supply path, does not allow the air to enter on the way of the path even in the state of the ink jet apparatus being moved or being positioned aslant, thus eliminating ink leakage. Also, irrespective of the use environment and arrangement condition of the ink jet apparatus, there is no possibility that ink flows unexpectedly in the ink flow path from the air communication port to the ink supply path.

The ink supply needle 205a is connected with the ink supply tube 206 through the liquid flow path 205c, the cutting off valve 210, and the flow path 205d. The air inducing needle 205b is communicated with the air outside by way of the flow path 205e, the buffer chamber 205f, and the atmospheric communication port 205g. Both the liquid path 205c, which is positioned at the lowest height of the passage from the ink supply needle 205a to the ink supply tube 206, and the liquid path 205e, which is positioned at the lowest height of the passage from the air inducing needle 205b to the atmospheric communication portio 205g, are on the same height. The present embodiment uses the ink supply needle 205a and the air inducing needle 205b each having the large inner diameter of 1.6 mm, and the needle hole of 1.0 to 1.5 mm diameter.

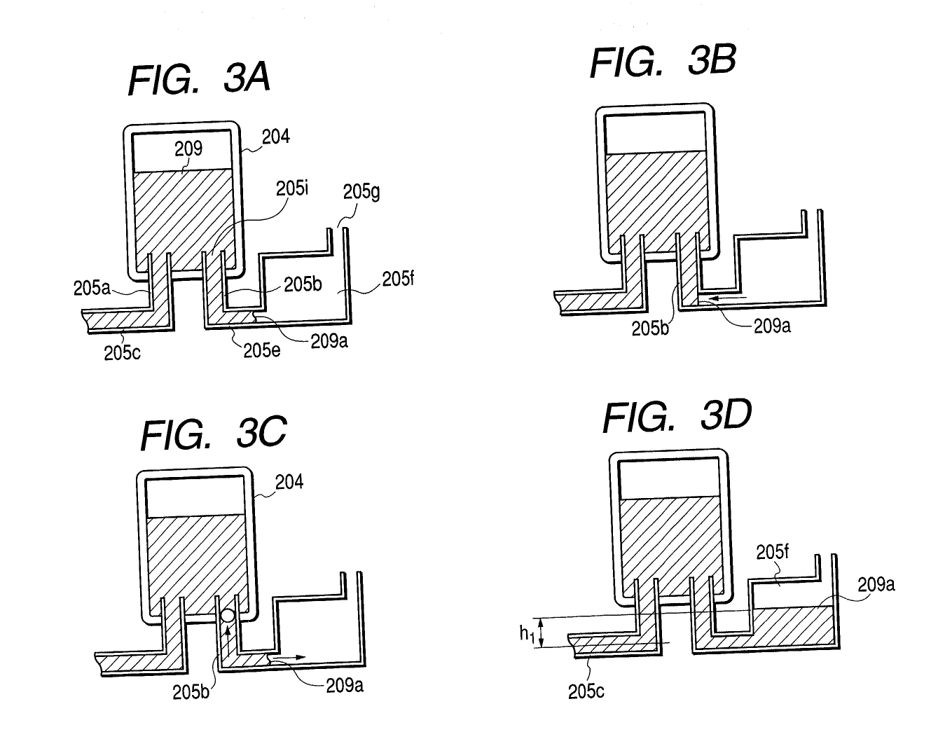

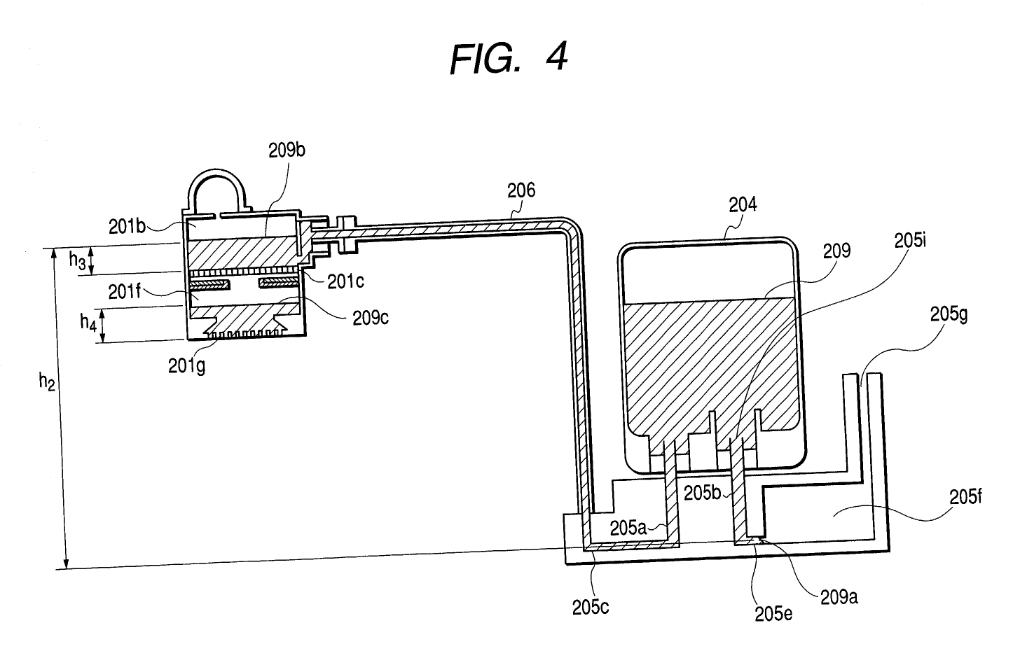

Also, in order to prevent ink leakage from the atmospheric communication port 205g, the buffer chamber 205f is arranged to communicate with the atmospheric communication port 205g through the liquid path 205j that passes the position higher than the upper opening 205i of the air inducing needle 205b. For example, even if the main tank 204 having ink contained therein is installed erroneously without the installation of the recording head 201, and the cutting off valve 210 is open, the air is induced into the main tank 204 by means of the ink supply needle 205a. In this case, the leading end of the ink supply needle 205a has the atmospheric pressure, and ink begins to flow to a lower part and leaks if the atmospheric communication port 205g is positioned lower than the upper opening 205i. To avoid such problem as this, the buffer chamber 205f is communicated with the atmospheric communication port 205g through the liquid path 205j that passes the position higher than the upper opening 205i. In this respect, the same effect is obtainable with the structure in which the atmospheric communication port 205g itself is positioned higher than the upper opening 205i as shown in FIGS. 3A, 3B, 3C and 3D and in FIG. 4, for example.

The cutting off valve 210 is provided with a diaphragm 210a formed by the rubber material that conducts the opening and closing between the two liquid paths 205c and 205d are conducted with the disposition of the diaphragm 210a. On the upper face of the diaphragm 210a, a cylindrical spring holder 210b is fixed to contain a pressure spring 210c therein. With the pressure spring 210c, the diaphragm 210a is squashed to cut off between the liquid paths 205c and 205d. The spring holder 210b is provided with the flange which the lever 210d engages by the operation of the link 207e of the recovery unit 207 to be described later. When the lever 210d operates to hold up the spring holder 210b against the spring force of the pressure spring 210c, the liquid paths 205c and 205d are communicated. The cutting off valve 210 is open when the recording head 201 discharges ink, and closed when the recording head is on standby or at rest. During the ink filling operation which will be described later, the cutting off valve is open or closed in synchronism with the operation timing of the recovery unit 207.

The ink supply unit 205 structured as described above is provided per main tank 204, that is, per ink color, with the exception of the lever 210d. The use of the lever 210d is shared by all the colors to open or close the cutting off valve 210 simultaneously with respect to all the colors.

With the structure thus arranged, ink is supplied from the main tank 204 to the recording head 201 all the time through the ink supply unit 205 and the ink supply tube 206 by means of the negative pressure resulting from the consumption of ink in the recording head 201. At this juncture, the same amount of air as that of ink supplied from the main tank 204 is induced from the atmospheric communication port 205g into the main tank 204 by way of the buffer chamber 205f and the air inducing needle 205b.

The buffer chamber 205f is a space to aim at provisionally retaining the ink that has flown out form the main tank 204 due to the expansion of air in the main tank 204, and the lower end of the air inducing needle 205b is positioned at the bottom of the buffer chamber 205f. In other words, the buffer chamber 205f is structured to be a space expanded upward from the lower end of the air inducing needle 205b in the gravitational direction. If the air in the main tank 204 is expanded due to the increased environmental temperature or the like while the ink jet recording apparatus is on standby or at rest, ink in the main tank 204 flows out to the buffer chamber 205f from the air inducing needle 205b through the liquid path 205e, because the cutting off valve 210 is closed. On the contrary, if the air in the main tank 204 is contracted due to the decreased temperature or the like, the ink that has flown out into the buffer chamber 205f returns to the main tank 204 through the lower end of the air inducing needle 205b positioned on the bottom of the buffer chamber 205f. Also, when ink is discharged from the recording head 201 in a state of ink existing in the buffer chamber 205f, the ink that exists in the buffer chamber 205f returns to the main tank 204 at first. Then, after ink no longer exists in the buffer chamber 205f, the air is induced into the main tank 204.

The opening of the air inducing needle 205b to the buffer chamber 205f is formed to be in a diameter good enough to provide the meniscus of ink.

The volume V_{b} of the buffer chamber 205f should be set to satisfy the use environment of the product. Here, given the lower limit of the use environmental temperature of an apparatus as T₁ K, and the upper limit, as T₂ K, and the volume of the ink tank as Vₜ, it becomes possible to prevent ink leakage if the V_{b}>V_{t×(T}₂−T₁)/T₂. Now, for example, assuming that a product is within the use environmental temperature of 5° C. (278 K) to 35° C. (308 K), the V_{b} to be set for the buffer chamber=100×(308−278)/308=9.7 ml or more where the volume Vₜ of the main tank 204=100 ml.

In this respect, with reference to FIGS. 3A, 3B, 3C and 3D, the description will be made of the fundamental water head of the main tank 204, and the behavior of the air and ink in the liquid path of the ink supply unit 205 when the air is induced into the main tank 204.

FIG. 3A shows the usual state in which ink can be supplied from the main tank 204 to the recording head 201 (see FIG. 2). In this state, the interior of the main tank 204 is airtight with the exception of the buffer chamber 205f. The interior of the main tank 205 is kept in negative pressure. The tip 209a of ink remains in the midway of the liquid path 205e. The pressure of the tip 209a of ink is the atmospheric pressure (=101.3 kPa), because it is in contact with the atmosphere. The liquid path 205c where the tip 209a of ink is positioned, and the liquid path 205e with which the ink supply tube 206 (see FIG. 2) communicates are at the same height, and only ink between both liquid paths 205c and 205e is allowed to be communicated. Therefore, the pressure in the liquid path 205c is also the atmospheric pressure. This is determined by the relationship between the tip 209a of ink and the height of the liquid path 205c, and it is not affected by the amount of ink 209 in the main tank 204.

When ink in the main tank 204 is consumed, the tip 209a of ink gradually moves in the direction toward the air inducing needle 205b as shown in FIG. 3B, and when it reaches the point immediately under the air inducing needle 205b, it becomes a bubble as shown in FIG. 3C and floats up in the air inducing needle 205b to be induced into the main tank 204. Then, in place thereof, ink in the main tank 204 enters the air inducing needle 205b, and the tip 209a of ink returns to the original state as shown in FIG. 3A.

FIG. 3D shows the state where ink is retained in the buffer chamber 205f. In this case, the tip 209a of ink is positioned higher than the liquid path 205c only by h1 mm in the middle of the height direction of the buffer chamber 205f, and the pressure in the liquid path 205c becomes −9.8 h1 Pa.

As described above, in accordance with the present embodiment, the pressure exerted by the water head differential of the nozzle 201g (see FIG. 2) indicates the negative pressure Pₙ at the lower end of the nozzle 201g is Pₙ −9.8(h2-h3-h4) Pa in the usual state where, as shown in FIG. 4, the height from the flow path 205c to the upper face 209b of ink in the sub-tank 201b is h2 mm; the height from the filter 201c to the upper face 209b of ink in the sub-tank 201b is h3 mm; and the height from the lower end of nozzle 201g to the upper face 209c of ink in the liquid chamber 201f is h4 mm, and it indicates Pₙ −9.8(h2-h1-h3-h4) Pa in the state of ink being retained in the buffer chamber 205f. The value Pₙ is set to be within the range of the aforesaid range of negative pressure of (−0.4 kPa to −2.0 kPa).

Now, again, referring to FIG. 2, a circuit 205h is connected with the ink supply needle 205a and the air inducing needle 205b to measure the electric resistance of ink, and the presence and absence of ink in the main tank 204 is made detectable. The circuit 205h detects the electrical closing if there is ink residing in the main tank 204, because electric current runs through the circuit 205h with the intervention of ink in the main tank 204, and it detects the electrical open if ink does not exist or the main tank 204 is not installed. Since the detecting current is extremely small, it is important to insulate the ink supply needle 205a and the air inducing needle 205b as well. In accordance with the present embodiment, the passage from the ink supply needle 205a to the recording head 201, and the passage from the air inducing needle 205b to the atmospheric communication port 205g are made completely independent, and utmost care is taken to make it possible to measure the electric resistance of ink only in the main tank 204.

Next, a recovery unit 207 will be described.

The recovery unit 207 operates the suction of ink and air from the nozzle 201g, as well as the opening and closing of the cut off valve 210, which comprises a suction cap 207a for capping the ink discharge surface (where the nozzle 201g is open) of the recording head 201 and a link 207e that operates the lever 210d for the cutting off plane 210.

The suction cap 207a is formed by the elastic member, at least the portion thereof, which is in contact with ink discharge surface, being rubber or the like, and installed movably between the position where it airtightly closes the ink discharge surface and the position where it retracts from the recording head 201. To the suction cap 207a, the tube having a suction pump 207c of tube pump type arranged on the middle portion thereof is connected to make it possible to perform suction continuously by driving the suction pump 207c by use of a pump motor 207d. It is also made possible to change the suction amount corresponding to the rotational amount of the pump motor 207d. For the present embodiment, a suction pump capable of reducing pressure to 40.5 kPa is used as the pump 207c.

The cam 207b operates the suction cap 207a. By use of a cam control motor 207g, the link 207e operates in synchronism with the movement of the cam 207f. The timing at which the cam 207b is in contact with the suction cap 201g at the positions a to c, respectively, is identical with the timing at which the cam 207f is in contact with the link 207e at the positions a to c, respectively. At the position a, the cam 207b enables the suction cap 201g to part from the ink discharge surface of the recording head 201, and the cam 207f pushes the link 207e to raise the lever 210d to open the cut off valve 210. At the position b, the cam 207b enables the suction cap 201g to be closely in contact with the ink discharge surface, and the cam 207f draws back the link 207e to close the cut off valve. At the position c, the cam 207b enables the suction cap 207a to be airtightly in contact with the ink discharge surface, and the cam 207f pushes the link 207e to open the cut off valve 210.

In the recording operation, the cams 207b and 207f are set at the position a so that ink is discharged from the nozzle 201g, and the ink supply from the main tank 204 to the recording head 201 is made possible. When recording is not in operation, which includes the state of being on standby and at rest, the cams 207b and 207f are set at the position b to prevent the nozzle 201g from being dried, while preventing ink from flowing out from the recording head 201 (particularly when the apparatus itself should be carried for another location, there may a case where the apparatus is inclined to allow ink to flow out). The position c for the cams 207b and 207f is used for ink filling to the recording head 201 as given below.

Now, the description has been made of the ink supply path from the main tank 204 to the recording head 201. With a structure as shown in FIG. 2, however, it is inevitable that the air is accumulated in the recording head 201 in a long run.

In the sub-tank 201b, there are accumulated the air that has permeated the ink supply tube 206 and the elastic member 201h to enter it, and the air that has been dissolved to reside in ink. As to the air that permeates the ink supply tube 206 and the elastic member 201h, it may be possible to use a structural material having a high gas barrier capability for them, but the material having a high gas barrier capability is too expensive to be used easily for the commercial equipment manufactured on a large scale with the cost aspect in view. For the present embodiment, the low-cost and highly flexible polyethylene tube, which is easy to handle, is used for the ink supply tube 206, and butyl rubber is used for the elastic member 201h.

Meanwhile, the air is gradually accumulated in the liquid chamber 201f because the bubble, which has been generated in ink by film boiling for discharging ink from the nozzle 201g, is split to return to the liquid chamber 201f or because fine bubbles dissolved to reside in ink are gathered to become a large bubble as the temperature of ink is increased in the nozzle 201g.

In accordance with the experiments conducted by the inventors hereof, the structure of the present embodiments allows the amount of air accumulation in the sub-tank 201b is approximately 1 ml per month, and the amount of air accumulation in the liquid chamber 201f is approximately 0.5 ml per month.

In the amount of air accumulation is large in the sub-tank 201b and the liquid chamber 201f, the amount of ink retained in each of the sub-tank 201b and the liquid chamber 201f is reduced eventually. As a result, in the sub-tank 201b, if ink becomes short, the filter 201c is exposed to the air to reduced the effective area of the filter 201c. Then, the pressure loss of the filter 201c increases to make it impossible to supply ink to the liquid chamber 201f in the worst case. On the other hand, if the upper end of the nozzle 201g is exposed to the air in the liquid chamber 201f, the ink supply to the nozzle 201g is disabled. Therefore, there is a possibility that a critical problem is encountered unless more than a specific amount of ink is retained both in the sub-tank 201b and the liquid chamber 201f.

Thus, an appropriate amount of ink is filled each in the sub-tank 201b and the liquid chamber 201f per specific period in order to maintain the ink discharge function for a long time even without using an expensive material having gas-barrier capability. In the case of the present embodiment, for example, it should be good enough if only ink is filled in the sub-tank 201b and the liquid chamber 201f per month in an amount equivalent to the amount of air accumulation per month plus variation at the time of respective ink filling.

The ink filling to the sub-tank 201b and the liquid chamber 201f is conducted by the utilization of suction operation of the recovery unit 207. In other words, the suction pump 207c is driven in a state of the ink discharge surface of the recording head 201 being airtightly closed by use of the suction cap 201a. Then, ink in the recording head 201 is sucked through the nozzle 201g. However, if only ink is sucked from the nozzle 201g, substantially the same amount of ink as the ink sucked from the nozzle 201g is allowed to flow from the sub-tank 201b to the liquid chamber 201f. Likewise, substantially the same amount of ink as the ink that has flown out from the sub-tank 201b is allowed to flow out from the main tank 204 into the sub-tank 201b. Here, the situation remains almost unchanged from the one before suction.

In accordance with the present embodiment, therefore, the cut off valve 210 is utilized for the reduction of the pressure each in the sub-tank 201b and the liquid chamber 201f to a designated pressure in order to fill an appropriate amount of ink each in the sub-tank 201b and the liquid chamber 201f, which are partitioned by use of the filter 201c. In this manner, the volume setting is conducted for both sub-tank 201b and the liquid chamber 201f.

Hereunder, the description will be made of the ink filling operation and the volume setting with respect to the sub-tank 201b and the liquid chamber 201f.

To operate ink filling, the carriage 202 (see FIG. 1) is allowed to move to the position where the recording head 201 faces the suction cap 207a at first, and then, the cams 207b and 207f are driven by the cam control motor 207g of the recovery unit 207 to rotate them so that the position b is in contact with the suction cap 107a and the link 207e, respectively. In this way, the ink discharge surface of the recording head 201 is airtightly closed by the suction cap 207a, and the cut off valve 210 is in a state of closing the ink path from the min tank 204 to the recording head 201.

In this state, the pump motor 207d is driven to conduct suction from the suction cap 207a by use of the suction pump 207c. With this suction, the remaining ink and air in the recording head 201 are sucked through the nozzle 201g, and the inner pressure of the recording head 201 is reduced. When the suction amount of the suction pump 207c reaches a designated amount, the suction pump 207c is suspended, and the cam control motor 207g is driven to rotate the cams 207b and 207f so that the position c is in contact with the suction cap 207a and the link 207e, respectively. In this way, the cut off valve 210 is open while the suction cap 207a remains to airtightly close the ink discharge surface. The suction amount of the suction pump 207c is the one that makes the inner pressure of the recording head 201 a specific pressure needed to fill ink in the sub-tank 201b and the liquid chamber 201f in an appropriate amount, respectively. This can be obtained by calculation, experiment, or the like.

When the inner pressure of the recording head 201 is reduced, ink flows into the recording head 201 through the ink supply tube 206, and the sub-tank 201b and the liquid chamber 201f are filled with ink, respectively. The amount of ink to be filled is the volume needed for the decompressed sub-tank 201b and liquid chamber 201f to return to substantially having the atmospheric pressure, respectively, which is determined by the respective volume and pressure of the sub-tank 201b and liquid chamber 201f.

The ink filling to the sub-tank 201b and the liquid chamber 201f is complete in approximately 1 second after the cut off valve 210 has been open. With the completion of the ink filling, the cam control motor 207g is driven to rotate the cams 207b and 207f so that the position b is in contact with the suction cap 207a and the link 207e, respectively. In this way, the suction cap 207a is allowed to part from the recording head 201. Then, the suction pump 207c is again driven to suck the remaining ink in the suction cap 207a. Also, in this state, the cut off valve 210 is in the state of being open to make it possible to form characters, images, or the like on a recording sheet S (see FIG. 1) by discharging ink from the nozzle 201g. Here, if the operation is on standby or at rest, the cam control motor 207g is again driven to rotate the cams 207b and 207f so that the position b is in contact with the suction cap 207a and the link 207e, respectively. Thus, the ink discharge surface of the recording head 201 is airtightly covered by the suction cap 201a, and the cut off valve 210 is closed.

If the amount of ink in the sub-tank 201b and the liquid chamber 201f does not become short for a long time, there is no need for any frequent suction operation to be conducted by use of the recovery unit 207, and the occasion also becomes less for any wasteful use of ink. Further, even if ink should be filled both in the sub-tank 201b and the liquid chamber 201f, only a one-time filling operation will suffice so as to save the consumption of ink.

Here, the volume of the sub-tank 201b is given as V1; the amount of ink to be filled in the sub-tank 201b as S1; and the inner pressure of the sub-tank 201b as P1 (relative value to the atmospheric pressure). Now, from the principle of “PV=constant”, it becomes possible to fill ink in the sub-tank 201b in an appropriate amount by the execution of the filling operation so that the relations between them can be set at V1=S1/P1. Likewise, the volume of the liquid chamber 201f is given as V2; the amount of ink to be filled in the liquid chamber 201f as S2; and the inner pressure of the liquid chamber 201f as P2 (relative value to the atmospheric pressure). Now, if the relations therebetween are set to be V2=S2/P2, it becomes possible to fill ink in the liquid chamber 201f in an appropriate amount by the execution of the filling operation.

Also, the filter 201c that partitions the sub-tank 201b and the liquid chamber 201f is formed with a fine mesh to make it difficult for the air to flow through in the state of meniscus being formed as described earlier. Here, the pressure needed for the air to pass the filter 201c having the meniscus formed therefor is given as Pm. When suction is made for the nozzle 201g by use of the recovery unit 207, the inner pressure P2 of the liquid chamber 201f is made lower than the inner pressure P1 of the sub-tank 201b only by the portion Pm described above in order to enable the air in the sub-tank 201b to pass by way of the filter 201c. Thus, with this relationship being used for setting the volume of the sub-tank 201b and the liquid chamber 201f as well, it becomes easier to determine the conditions of filling operation.

Here, the description will be made of the specific example of the aforesaid filling operation and volume setting.

The ink filling is executed once a month. The amount of air accumulated during a month is assumed to be 1 ml for the sub-tank 201b, and 0.5 ml for the liquid chamber 201f. Also, the amount of ink needed not to allow the filter 201c to be exposed to the air in the sub-tank 201b is assumed to be 0.5 ml, and the amount of ink needed not to allow the nozzle 201g to be protruded to the air in the liquid chamber 201f is assumed to be 0.5 ml. The variation of the ink filling amount is assumed to be 0.2 ml both for the sub-tank 201b and the liquid chamber 201f. These numerical values are obtained by experiments. From the above, the amount of ink to be filled per filling is the total of these values, and set at 1.7 ml for the sub-tank 201b and 1.2 ml for the liquid chamber 201f.

The range of pressure reduction in the recording head 201 is set at the value that does not exceed the capability of the recovery unit 207. For the present embodiment, the capability limit of the suction pump 207c is −60.8 kPa, and the suction amount of the suction pump 207c is obtained by experiments so that the inner pressure of the suction cap 207a becomes −50.6 kPa providing some room, which is controlled as the rotational amount of the pump motor 207b.

Here, owing to the presence of meniscus of the nozzle 201g, the pressure needed to enable the air to pass is −5.1 kPa (experimental value). Therefore, difference occurs between the inner pressure of the suction cap 207a and the inner pressure of the liquid chamber 201f by the portion equivalent to the resistance of the nozzle 201g. Thus, the inner pressure of the liquid chamber 201f becomes higher than that of the cap 207a by 5.1 kPa. Likewise, owing to the presence of the meniscus of the filter 201c, the pressure needed to enable the air to pass is −10.1 kPa (experimental value). Therefore, difference occurs between the inner pressure of the liquid chamber 201f and the inner pressure of the sub-tank 201b by the portion equivalent to the resistance of the filter 201c. Thus, the inner pressure of the sub-tank 201b becomes higher than that of the liquid chamber 201f by 10.1 kPa. Therefore, if the inner pressure of the suction cap 207a is set at −50.7 kPa, the inner pressure of the liquid chamber 201f becomes −45.6 kPa and the inner pressure of the sub-tank 201b becomes −35.5 kPa.

In order to fill ink of 1.7 ml in the sub-tank 201b, the volume V1 of the sub-tank 201b is set so as to make the inner pressure thereof to be −35.5 kPa when ink of 1.7 ml is sucked form the sub-tank 201b whose inner pressure is almost 101.3 kPa at that time. In other words, the setting is V1=1.7/0.35=4.85 ml. Likewise, for the volume V2 of the liquid chamber 201f, the setting is V2=1.2/0.45=2.67 ml.

After the inner pressure of the recording head 201 is reduced on the aforesaid conditions, the cut off valve 210 is open to enable ink to flow into the recording head 201 the inner pressure of which has been made negative. To described more precisely, ink flows into the sub-tank 201b at first, and then, the air that has expanded to the V1 due to the reduced pressure is restored almost to the atmospheric pressure. Then, given the volume of the air in the sub-tank 201b as V1ₐ, the V1ₐ=V1×(1−0.35)=3.15 ml, and when ink of V1−V1ₐ=1.7 ml is filled in the sub-tank 201b, it settles down. Likewise, ink flows into the liquid chamber 201f form the sub-tank 201b, and the air that has expanded to the V2 due to the reduced pressure is restored almost to the atmospheric pressure. Then, given the volume of the air in the liquid chamber 201f as V2ₐ, the V2ₐ=V2×(1−0.45)=1.47 ml, and when ink of V2−V2ₐ=1.2 ml is filled in the liquid chamber 201f, it settles down.

As described above, if each of the volumes and pressures to be reduced is set for the sub-tank 201b and the liquid chamber 201f, it becomes possible to fill in the sub-tank 201b and the liquid chamber 201f partitioned by the filter 201c each appropriate amount of ink by the one-time filling operation, and perform normal operation for a long time without suction operation even under the circumstance that the air is accumulated in the recording head 201.

Also, as described earlier, an air layer exists between the filter 201c and the upper face of ink in the liquid chamber 201f. However, the amount of this air layer can be set arbitrarily by means of the sucking pressure of the suction operation of the recovery unit 207. In other words, this air layer is the one that can be controlled.

This arrangement makes it possible to improve reliability significantly against the discharge defects that may be brought about conventionally by the bubble generated between the filter and nozzle. In other words, the problem encountered in the conventional art that the effective area of the filter is caused to change (to be reduced) due to the presence of uncontrollable bubble under the filter is now simply taken into consideration in the stage of designing, because according to the present embodiment the filter 201c is in contact with the air layer at the portion (the opening portion at 201d in FIG. 2), which is controlled from the beginning so that the effective area of the filter 201c is not allowed to change. Also, to deal with the problem that bubble may clog the flow path between filter and nozzle, the sectional area of the liquid chamber 201f is formed to be large enough against the diameter of the bubble that may be allowed to reside in the liquid chamber 201f to eliminate any possibility that the bubble in the liquid chamber 201f blocks the flow of ink. Further, regarding the problem that the bubble in the liquid chamber may enter the nozzle or clog the communication passage between the liquid chamber and nozzle, there is no possibility that it enters the nozzle 201g, because the sectional area of the liquid chamber 201f is large enough as described above so that the bubble generated in the liquid chamber 201f ascends in ink in the liquid chamber 201f by means of its floating power to be combined with the air layer. Furthermore, this air layer is controllable as described above, and there is no possibility that the effective area of the filter 201c does not change even if the bubble generated in the liquid chamber 201f is combined with the air layer.

In other words, with the liquid chamber 201f structured to be partitioned from the sub-tank 201b by use of the filter 201c, it becomes possible to significantly enhance reliability against the discharge defects that may be caused by the generation of bubble in the liquid chamber 201f, and the movement of the bubble thus generated.

As described above, according to the ink supply mechanism of the present invention, the first and second hollow needles are inserted into each connector of ink tank serving as the main tank for communication to make them one flow path airtightly closed to the atmosphere between the atmospheric communication port and the ink supply path through the ink tank. In other words, with the arrangement to make the passage from the atmospheric communication port to the ink supply path one closed flow path, it becomes possible to eliminate the flow-in of air on the midway of the flow path, as well as the ink leakage, while blocking the movement of ink in the flow path. As a result, it is possible to prevent any ink leakage from the atmospheric communication port that may be caused due to the inclination of the main body or the like.

Also, with the measurement of the value of electric resistance between the first and second hollow needles formed by conductive material, there is no possibility to detect any resistance of ink residing outside the ink tank. Consequently, not only the presence and absence of ink in the ink tank can be detected correctly, but also, whether or not the ink tank is installed can be detected, hence making it possible to grasp the recordable conditions exactly.

What is claimed is:

1. An ink supply mechanism for supplying ink from an ink tank to a recording head, comprising:
an ink tank freely attachable and detachable, having ink retained therein and two connectors provided for the bottom thereof for enabling the inside thereof to be communicated with the outside, wherein
a first hollow needle communicated with the ink supply path for supplying ink to said recording head is inserted into one of said connectors for communication, and a second hollow needle communicated with the bottom of the atmospheric communication chamber communicated with the atmosphere through an atmospheric communication port is inserted into the other one of said connectors for communication to form one flow path airtightly closed to the atmosphere from said atmospheric communication port to said ink supply path through said ink tank.

2. An ink supply mechanism according to claim 1, wherein said first hollow needle and second hollow needle are formed by conductive material, and a circuit is provided to measure the value of electric resistance between said first and second hollow needles.

3. An ink supply mechanism according to claim 1, wherein said atmospheric communication chamber is a space expanded from the lower end of said second hollow needle upward, and the atmospheric communication port provided for said atmospheric communication chamber is arranged at a position higher than the opening of said second hollow needle on the insertion side thereof into said connector for communication.

4. An ink supply mechanism according to claim 2, wherein said atmospheric communication chamber is a space expanded from the lower end of said second hollow needle upward, and the atmospheric communication port provided for said atmospheric communication chamber is arranged at a position higher than the opening of said second hollow needle on the insertion side thereof into said connector for communication.

5. An ink supply mechanism according to claim 1, wherein part of the path between said atmospheric communication port and said second hollow needle is positioned to be higher than the opening of said second hollow needle on the insertion side thereof into said connector for communication.

6. An ink supply mechanism according to claim 2, wherein part of the path between said atmospheric communication port and said second hollow needle is positioned to be higher than the opening of said second hollow needle on the insertion side thereof into said connector for communication.

7. An ink supply mechanism according to claim 1, wherein the volume of said atmospheric communication chamber satisfies
Va>Vt×(T₂−T₁)/T₂
where T₁: the lower limit temperature of use environmental temperature
T₂: the upper limit temperature of use environmental temperature
Va: the volume of said atmospheric communication chamber
Vt: the volume of said ink tank

8. An ink supply mechanism according to claim 2, wherein the volume of said atmospheric communication chamber satisfies
Va>Vt×(T₂−T₁)/T₂
where T₁: the lower limit temperature of use environmental temperature
T₂: the upper limit temperature of use environmental temperature
Va: the volume of said atmospheric communication chamber
Vt: the volume of said ink tank

9. An ink supply mechanism according to claim 3, wherein the volume of said atmospheric communication chamber satisfies
Va>Vt×(T₂−T₁)/T₂
where T₁: the lower limit temperature of use environmental temperature
T₂: the upper limit temperature of use environmental temperature
Va: the volume of said atmospheric communication chamber
Vt: the volume of said ink tank

10. An ink supply mechanism according to claim 4, wherein the volume of said atmospheric communication chamber satisfies
Va>Vt×(T₂−T₁)/T₂
where T₁: the lower limit temperature of use environmental temperature
T₂: the upper limit temperature of use environmental temperature
Va: the volume of said atmospheric communication chamber
Vt: the volume of said ink tank

11. An ink supply mechanism according to claim 5, wherein the volume of said atmospheric communication chamber satisfies
Va>Vt×(T₂−T₁)/T₂
where T₁: the lower limit temperature of use environmental temperature
T₂: the upper limit temperature of use environmental temperature
Va: the volume of said atmospheric communication chamber
Vt: the volume of said ink tank

12. An ink supply mechanism according to claim 6, wherein the volume of said atmospheric communication chamber satisfies
Va>Vt×(T₂−T₁)/T₂
where T₁: the lower limit temperature of use environmental temperature
T₂: the upper limit temperature of use environmental temperature
Va: the volume of said atmospheric communication chamber
Vt: the volume of said ink tank

13. An ink supply mechanism comprising:
an ink supply path for supplying ink to a recording head connected with an ink tank capable of being attached to and detached from a recording apparatus; and
an atmospheric communication path connected with said ink tank to condition said ink tank to be communicated with the atmosphere, wherein
said ink supply path and said atmospheric communication path are made communicative as one path through said ink tank only in the state of being connected with said ink tank, and said ink supply path and said atmospheric communication path are cut off in a state of said ink tank being unmounted.

14. An ink jet recording apparatus provided with conveying means for conveying a recording medium to perform recording by discharging ink from a recording head to said recording medium, comprising:
an ink supply mechanism according to claim 1.

15. An ink jet recording apparatus provided with conveying means for conveying a recording medium to perform recording by discharging ink from a recording head to said recording medium, comprising:
an ink supply mechanism according to claim 2.

16. An ink jet recording apparatus provided with conveying means for conveying a recording medium to perform recording by discharging ink from a recording head to said recording medium, comprising:
an ink supply mechanism according to claim 3.

17. An ink jet recording apparatus provided with conveying means for conveying a recording medium to perform recording by discharging ink from a recording head to said recording medium, comprising:
an ink supply mechanism according to claim 4.

18. An ink jet recording apparatus provided with conveying means for conveying a recording medium to perform recording by discharging ink from a recording head to said recording medium, comprising:
an ink supply mechanism according to claim 5.

19. An ink jet recording apparatus provided with conveying means for conveying a recording medium to perform recording by discharging ink from a recording head to said recording medium, comprising:
an ink supply mechanism according to claim 6.

20. An ink jet recording apparatus provided with conveying means for conveying a recording medium to perform recording by discharging ink from a recording head to said recording medium, comprising:
an ink supply mechanism according to claim 7.

21. An ink jet recording apparatus provided with conveying means for conveying a recording medium to perform recording by discharging ink from a recording head to said recording medium, comprising:
an ink supply mechanism according to claim 8.

22. An ink jet recording apparatus provided with conveying means for conveying a recording medium to perform recording by discharging ink from a recording head to said recording medium, comprising:
an ink supply mechanism according to claim 9.

23. An ink jet recording apparatus provided with conveying means for conveying a recording medium to perform recording by discharging ink from a recording head to said recording medium, comprising:
an ink supply mechanism according to claim 10.

24. An ink jet recording apparatus provided with conveying means for conveying a recording medium to perform recording by discharging ink from a recording head to said recording medium, comprising:
an ink supply mechanism according to claim 11.

25. An ink jet recording apparatus provided with conveying means for conveying a recording medium to perform recording by discharging ink from a recording head to said recording medium, comprising:
an ink supply mechanism according to claim 12.

26. An ink jet recording apparatus provided with conveying means for conveying a recording medium to perform recording by discharging ink from a recording head to said recording medium, comprising:
an ink supply mechanism according to claim 13.
